(19) United States
(12) Patent Application Publication
(10) Pub. No.: US 2020/0292248 A1
(43) Pub. Date: Sep. 17, 2020

(54) VEHICLE WITH A PASSENGER COMPARTMENT INSULATED BY A THERMAL BARRIER

(71) Applicant: Hutchinson, Paris (FR)

(72) Inventors: Fabrice Chopard, Saint Martin d'Hères (FR); Cédric Huillet, Montargis (FR); Fanny Geffray, Rennes (FR); Mathieu Leborgne, Montargis (FR)

(21) Appl. No.: 16/084,080

(22) PCT Filed: Mar. 9, 2017
(86) PCT No.: PCT/FR2017/050540

§ 371 Date: Sep. 11, 2018

(30) Foreign Application Priority Data
Mar. 11, 2016 (FR) 1652070

(51) Int. Cl. F28D 20/02

(52) U.S. Cl. CPC F28D 20/023; B60R 13/02; F28D 20/021

(57) ABSTRACT

The invention relates to thermal management of the passenger compartment of a vehicle comprising an air conditioner in the passenger compartment, suitable for heating, cooling and propelling air. At least one of the walls limiting the passenger compartment is provided, from the inside towards the outside, with an internal thermal barrier (containing at least one PCM material having a temperature at change of state between liquid and solid between 15° C. and 40° C. and preferably between 17° C. and 35° C., and at least one thermally insulating element.

The present invention relates to the field of thermal management.

It concerns in particular a vehicle comprising a passenger compartment delimited by walls interposed between the passenger compartment and an external environment and air conditioning means suitable for temporarily heating, cooling and propelling air into the passenger compartment.

It also covers a method for thermal management of the atmosphere in the passenger compartment.

Indeed, it is acknowledged that in order to ensure thermal management of a passenger compartment, it may be useful to be able to both insulate the volume of the passenger compartment from the external environment and even more finely:

manage the temperature therein within operational margins,

delay (or in some cases encourage) propagation of a heat flow from this volume towards the outside, or vice versa.

It is within this context that a method of thermal management of the atmosphere of this passenger compartment is hereby proposed, wherein:

at least part of the walls, from the inside in which the passenger compartment is situated, towards the outside, is provided with:
an internal thermal barrier containing at least one PCM material in thermal exchange with the passenger compartment air having a temperature at change of state between liquid and solid comprised between 15° C. and 40° C. and preferably between 17° C. and 35° C.,
and at least one thermally insulating element,

the vehicle being placed in an environment in which the PCM material is in a solid state and the temperature of the air in the passenger compartment increasing to more than 20° C., the said at least one PCM material is allowed to store thermal energy by liquefying through heat exchange with this air,

subsequently, if the temperature in the passenger compartment is deemed too high, fresh conditioned air derived from air conditioning means is temporarily introduced into the passenger compartment, in thermal exchange with said at least one PCM material, so that the incoming fresh conditioned air causes solidification of said at least one PCM material.

Combining than a barrier and a thermal insulation in this manner is all the more meaningful in a vehicle passenger compartment in that thermal management therein is tricky, as the temperature may in particular vary substantially and its external environment is complete, with temperature gradients that may reach several tens of ° C.

The insulating material will make it possible to limit the thermal exchanges between the inside and outside.

An PCM material will in particular make it possible, by thermal exchange and change of states:

if it acts as a selective thermal barrier, to delay propagation of a hot or cold front, by changing state,

if it acts as an independent thermal storage means, to store a thermal energy for releasing it later on to a structure and/or a fluid with which it will be in contact.

The first case may be regarded as preferable in a situation aiming to encourage a feeling of comfort by the vehicle occupant sensed as rapidly achieved, for example when s/he starts a conditioning of the passenger compartment with air conditioning, whereas a feeling of excessive heat was perceived on entering this passenger compartment.

An intended aim is also to limit the vehicle energy consumption related to the conditioning of the passenger compartment.

By means of the above solution, it should be possible to blow conditioned air at a temperature for example less lower in the above situation than that required in the absence of such a complex internal thermal barrier/thermal insulating element.

A difference of 1-2° C. appears achievable.

Moreover, this ought to be all the more feasible if an element is used as an internal thermal barrier in which said at least one PCM material is in a porous, open-porous matrix, so that said solidification causes a decrease in the thermal conductivity of said element.

Indeed, if the thermal energy controlling the temperature of the passenger compartment is provided by the air conditioning means and this thermal conductivity is furthermore reduced, therefore in principle that of the internal thermal barrier, which is doubled by the thermal insulation, it should be possible to limit energy losses and thus make the occupant of the passenger compartment experience more rapidly the feeling of comfort which he seeks and/or to require less air conditioning, hot or cold, for the same effect felt.

In addition, placing the temperature(s) of change(s) of state of the PCM(s) preferably between 17° C. and 35° C. will then encourage their transformation into the liquid state, as soon as a temperature often considered as the minimum “comfort” temperature (17° C.) is reached, with a liquid state at a substantially higher temperature, such as at or above 35° C., favoring the presence of solid PCM(s) for temperatures less than or equal to 35° C.

In terms of the equipment of a vehicle, the foregoing may be realised in such a way that the wall(s) interposed, i.e. between the passenger compartment and the external environment of the vehicle is/are provided at least partly, from the inside where the passenger compartment is situated, towards the outside:

with a thermal barrier containing at least one PCM material having a temperature at change of state between liquid and solid between 15° C. and 40° C. and preferably between 17° C. and 35° C. and in thermal exchange with the air of the passenger compartment derived at least in part from the air conditioning means,

and at least one thermally insulating element.

In this situation, it was noted above that it could be of value for the internal thermal barrier to comprise a porous matrix having open pores that vary according to the liquid or solid state of the PCM material, thus varying the thermal conductivity.

Using, for this internal thermal barrier, an expanding foam loaded with PCM(s) (free or not with respect to the foam network) will help to achieve the above-mentioned situation in which solidification of the PCM(s) leads to a favorable reduction in the thermal conductivity of the element(s) containing the latter.

In practice, it is proposed in this respect that the thermal barrier should have a thermal conductivity ratio between a situation in which the PCM material(s) are totally solid and a situation in which the PCM material(s) are totally liquid of between 1 and 10 (to within 20%).

This is achievable by an expanding foam loaded with pure PCM or by a set of capsules that are deformable, each of which have a variable volume and are therefore non-rigid, which may be made of elastomer, containing PCM(s), free or bonded to the foam by crosslinking or adhesion, for example.

In order to encourage the contraction/expansion effect within the thermal barrier, the PCM(s) of the internal thermal barrier will be encapsulated and will define a volume load of up to:

85% of the volume of the foam and of said capsules, when the PCM material is in the solid, crystallised state,

and/or 95% of the volume of the foam and of the capsules when the PCM is in the liquid state.

A volume load of between 45 and 85% and 55 and 95% respectively will be optimal, since below these values, the proportion makes the effect too uncertain and above, a lack of space may arise if the outer limits are imposed (the foam is constrained in a rigid environment).

For the performance of this insulation and a favorable efficiency/weight ratio, it is also advisable that the thermally insulating element should contain a porous, preferably nanoporous, material.

Again for this purpose and/or potentially mechanical purposes, it is further recommended that said thermally insulating element is arranged in a vacuum enclosure or series of vacuum enclosures to define at least one vacuum insulated panel (VIP). This may also usefully be the case for the thermal barrier.

In order to encourage overall thermal efficiency, it is also recommended that the change of state temperature or each change of state temperature of the PCM material(s) is/are (at least for some thereof) greater than or equal to the highest air cooling temperature and intake of air into the passenger compartment of the air conditioning means, or even greater than or equal to the lowest temperature of heating and intake of air of these same means.

If only one PCM material is used, a change of state temperature of between 20 and 25° C., or even 30-35° C., i.e. a fairly high temperature, will make it possible (when the vehicle is travelling) to easily keep the material solid in summer in very many cases, with a low thermal conductivity of the barrier and likewise in winter in many cases of conditioned passenger compartment heating.

In order to promote manufacture that is relatively simple and easy to implement, it is furthermore advisable, if several PCM materials having different temperature of change of state are to be used, that these should be dispersed in a support matrix.

Thus, there will temperatures in particular be no need to distribute the PCMs in successive sublayers.

Furthermore, in the event that several PCM materials are used in the internal thermal barrier, it may be deemed appropriate that they comprise at least:

a first PCM material having temperature of change of state of between 17° C. and 25° C., and

a second PCM material having a temperature of change of state of between 25° C. and 40° C.

Hence, the first will be liquid within the range of comfort temperatures and the second will be solid in the vast majority of cases, both in summer and in winter, in temperate regions.

### BRIEF DESCRIPTION OF THE DRAWINGS

If necessary, the invention will be better understood and other characteristics, details and advantages thereof will become apparent upon reading the following description as a non-exhaustive example with reference to the appended drawings in which:

FIG. 1 outlines a vehicle section having a passenger compartment, at least one outer wall of which is equipped with the thermal management device developed here,

FIGS. 2 and 3 outline such a wall in vertical section, in two possible versions thereof,

and FIGS. 4 and 5 outline a wall according to the invention in vertical section, in different operational situations.

### DETAILED DESCRIPTION

For all purposes, it is furthermore confirmed at this stage that a phase change material—or PCM—denotes any material capable of changing physical state, between liquid and solid, within a restricted temperature range of between −50° C. and 50° C. Heat transfer (or thermal transfer) can be achieved by using the Latent Heat (LH) thereof: the material can then store or transfer energy by a mere change of state, while maintaining a substantially constant temperature, that of the change of state.

The thermally insulating material(s) associated with the PCM(s) may be a “simple” insulation such as glass wool, but a foam, for example polyurethane or polyisocyanurate, or even more preferably a porous or even nanoporous thermally insulating material, arranged in a vacuum enclosure, to define at least one vacuum insulated panel, VIP, will definitely be preferred.

By “VIP” we understand a structure either filled with a gas having a thermal conductivity lower than that of the ambient air (26 mW/m·K) or under “vacuum”, i.e. under a pressure lower than the ambient pressure (therefore <10⁵ Pa). The partial air vacuum will in this case correspond to an internal pressure often between 10⁻² and 10⁴ Pa. The structure will comprise an airtight enclosure containing at least one thermally insulating material that is in principle porous or even nanoporous. With a porous insulation in a VIP structure, the performance of the thermal management to be ensured will be further improved, or even the overall weight reduced with respect to another insulation. Typically, the VIP panels (vacuum insulated panel, VIP) are thermal insulators in which at least one porous material, for example silica gel or silicic acid powder (SiO2), is pressed into a plate and surrounded with a wrapping foil, for example plastic and/or roll-formed aluminium. “Porous” designates a material having interstices enabling the passage of the air. Open-cell porous materials thus include foams but also fibrous materials (such as glass wool or rock wool). The interstices allowing passage that can be referred to as open pores have sizes of less than 1 or 2 mm so as to ensure proper thermal insulation, and preferably of 1 micron, and particularly preferably of 1 to 2×10⁻⁸ m (almost nanoporous structure), in particular for reasons of resistance to ageing and therefore of possibly less strong negative pressure in the VIP enclosure.

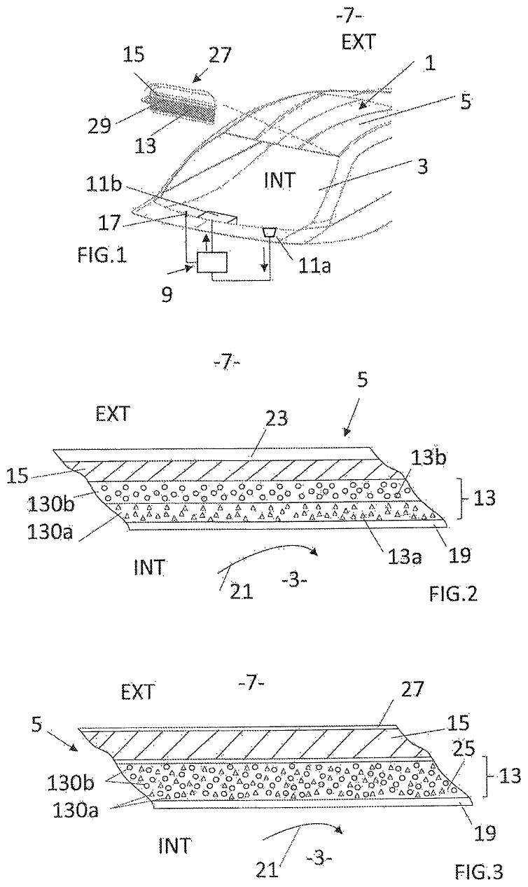

This being clarified, FIG. 1 therefore outlines a vehicle 1 comprising a passenger compartment 3, one wall 5 of which is equipped with a thermal management device.

The wall 5, in this case the wall of the hub (or roof), is one of those that externally limit the passenger compartment. It is therefore interposed between the internal passenger compartment 3 (INT) and an external environment 7 (EXT).

Other walls externally limiting the passenger compartment could be equipped with the following thermal management device below: For instance, a door wall.

What matters is that a vehicle wall is involved, the thermal management of which will affect the temperature inside the passenger compartment 3, as explained hereinafter.

Air conditioning means 9 enable to condition the air in the passenger compartment, via air extraction and supply vents 11a, 11b.

Thus, as known per se on existing vehicles, at certain times air is extracted, passes through the air conditioning means 9 to be heated or cooled and is subsequently propelled into the passenger compartment at a temperature different from that at which it was extracted.

Although this temporarily allows substantial adaptation of the temperature in the passenger compartment to the wishes of an occupant when s/he feels cold or heat coming from outside, such an air conditioning system is a heavy energy consumer and is typically only temporary.

This temporary nature may be ensured by manual action or for example by automatic adaptation via a setting adjusted on the console of the air conditioning means 9 accessible in the passenger compartment and controlled by a temperature sensor 17.

Thus, in order to improve thermal management inside the passenger compartment 3, it is proposed that one at least of the aforementioned walls, the wall 5 for example, should be provided, from the inside in which the passenger compartment is situated, towards the outside, with:

an internal thermal barrier 13 containing at least one PCM material having a temperature at change of state between liquid and solid between 15° C. and 40° C. and preferably between 17° C. and 35° C.,

and at least one thermally insulating element 15.

The thermal conductivity of each element of the thermal barrier 13 will of course be greater than that of any thermally insulating element 15.

That being said, it can be proved advantageous to use in the barrier 13 containing a PCM material within a porous matrix having open pores that will differ, typically in size and volume, depending on the liquid or solid state of the PCM material, thereby varying the thermal conductivity. One can thus envisage to use of an expanding foam loaded with encapsulated PCM fixed on the network of the foam, by crosslinking or by other means, for example adhesion (gluing) or suspension.

In such a case, the PCM material may occupy a greater volume in the liquid state. The pores of the porous matrix are then tightened. It will contain less air. In its solid state, the PCM material will in contrast occupy a smaller volume in this case. The pores of the porous matrix are therefore larger in volume. With an expanding foam, they will be expanded. The porous matrix will contain more air. The thermal conductivity of the thermal barrier 13 will then be lower.

Among the porous matrices and in particular the open porosity foams that can be used in a VIP, those having good resistance to compression during placement under vacuum will be selected, i.e.: under a pressure difference of 1 bar (10⁵ Pa), a deformation of less than 3% and preferably 2%, without which they collapse and lose in principle more than 10% or even 20% of thermal properties (conductivity). Hence, if a load of 1 bar is applied to the surface of the sample (such as a right-angled parallelepiped) in order to compress the latter uniaxially (according to its thickness), a deformation of 2% corresponds to the equation: e1−e2/e1×100; where:

e1: initial thickness of the sample,
e2: final thickness of the sample under a pressure of 1 bar.

The reference pressure under which the sample will display its initial thickness will typically be atmospheric pressure (10⁵ Pa), at ambient temperature (20° C.).

Polyurethane and polystyrene foams may be suitable.

Preferably, the thermal barrier will have a thermal conductivity ratio between a situation in which the PCM material(s) are totally solid and a situation in which the PCM material(s) are totally liquid of between 1 and 3, ideally more than 1 and approximately 10.

Thus, the effects explained hereinafter with reference to FIGS. 4-5 will befavored.

Despite external environments 7 that are sometimes rough, subjected to fluctuating and severe ambient temperatures (day/night, sun . . . ), the combination of the thermal barrier 13 with PCM material(s) and at least one thermal insulation 15 should make it possible to reduce the use of air conditioning means 9 and above all limit their energy consumption.

In this sense, it will in principle be preferable to plan that:

if the PCM material or each PCM material of the barrier 13 will store thermal energy by liquefying through thermal exchange with the air of the passenger compartment 3 if this air increases in temperature by up to more than 20° C. (for example, if the sun has heated the passenger compartment), after the vehicle 1 has been in an environment 3/7 where the PCM material or each PCM material has solidified, for example after a colder night, and subsequently,

if the temperature in the passenger compartment is deemed too high (the sun continues to heat), fresh conditioned air derived from air conditioning means 9 will be introduced into this passenger compartment, in thermal exchange with at least one of the PCM material, so that the incoming fresh conditioned air causes solidification of said at least one PCM material.

This should thus allow the occupant of the vehicle to perceive more quickly and/or sensitively the feeling of a change of temperature inside the passenger compartment brought about by the conditioned air supplied by the air conditioning means 9.

This effect ought to be all the more capable of being encouraged in that the temperature or each temperature at change of state of the PCM material considered in the barrier 13 will be greater than or equal to the highest air cooling temperature supplied into the passenger compartment of the air conditioning means 9 when these means 9 therefore blow fresh air at a temperature lower than that in the passenger compartment 3.

In practice, it could be considered that this “air cooling temperature supplied” will be the temperature at which the air is supplied into the passenger compartment, on leaving the air vents 11b. The temperature sensor 17 connected to the air conditioning means 9 will enable recording of the temperatures in the passenger compartment 3.

Typically, if the comfort temperature range in the passenger compartment 3 for an occupant of this passenger compartment is between 19° C. and 23° C., for example 21° C., the highest air cooling temperature supplied of the air conditioning means 9 can be arranged to be less than said minimum comfort temperature and therefore typically on the order of 16° C. to less than 21° C.

This will provide the cooling currently experienced in motor vehicles, when the cool/cold air conditioning function is activated.

If, rather than providing cold air conditioning, warm air conditioning is required, in winter for example, it will furthermore be preferable for said temperature of change of state to be greater than or equal in this case to the lowest air heating temperature supplied of these same air conditioning means 9, when these means 9 blow warmer air at a temperature greater than that in the passenger compartment 3 and typically greater than 21° C. in the case above.

Although only outlined very schematically in FIG. 1, the case of a barrier 13 with a single PCM material is highly realistic.

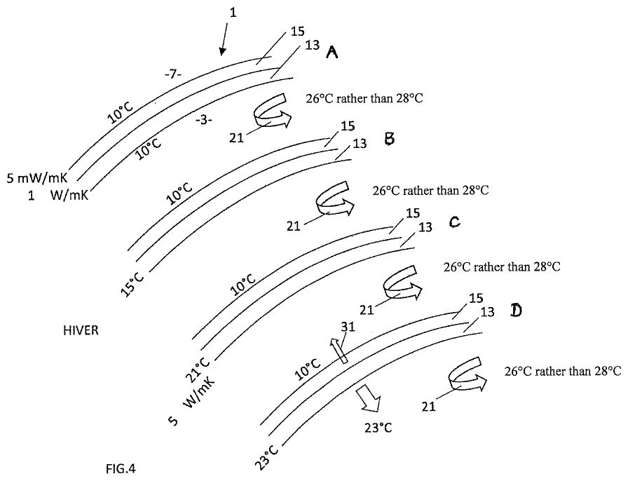

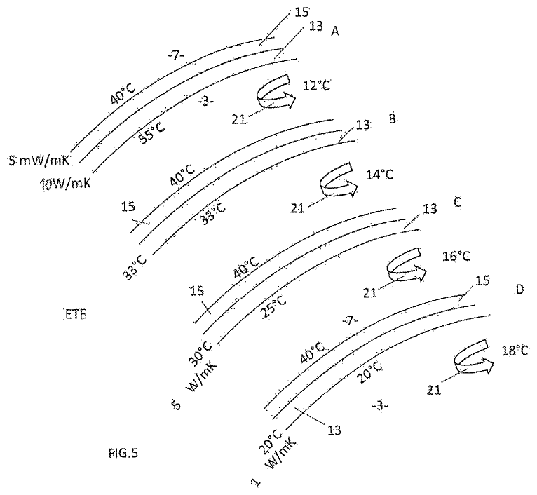

In FIGS. 2, 3, a situation is outlined however in which provision is made for several PCM materials with different temperature of change of state, for example in order to react with an optimised adjustment with a view to optimally maintaining the effectiveness of the thermally insulating element 15 and the rapid sensations of both heat and cold, during the air conditioning phases in the passenger compartment.

With two PCM materials, such as 13a, 13b, it will be possible to choose respective temperatures of change of state:

between 17° C. and 25° C., and

between 25° C. and 40° C.,

all to within 10% (see advantages in particular in connection with FIGS. 4-5).

In order to condition this or these PCM(s) in the wall 5, the former can be arranged, as outlined in FIG. 2, in several layers, such as 130a,130b, of materials each containing such a PCM material, with the PCM materials having temperature of change of states that are different from one another. The layer of PCM material with the lower temperature of change of state, such as 130a, will in this case be preferably located internally in relation to the layer of PCM material with the higher change of state temperature, such as 130b.

Another solution provides for the internal thermal barrier 13 having several PCM materials, such as 13a, 13b, having different temperature of change of states dispersed in a medium 25, as outlined in FIG. 3. Dispersion should preferably take place in a polymer resin matrix.

Possibly (at least) one structural and/or aesthetic intermediate layer 19 will exist between the PCM material layer(s) and the passenger compartment 3. The thermal conductivity through this layer 19 will be high in this case, typically greater than 25 mW/m·K. and a fine layer of fabric a few millimetres thick could be involved.

As outlined in FIG. 2, at least one other structural element 23 may also form part of the wall 5, such as a frame that will typically be part of the vehicle bodywork or a glass panel as found on the roofs of some vehicles.

The thermal management elements 13, 15 will then in principle be located internally in relation to the structural element 23 which they will line in this case on one side.

As regards execution of the thermally insulating element 15, it is advisable that it be arranged in at least one vacuum enclosure 27, in order to define at least one vacuum insulated panel, VIP, as outlined in particular in the enlargement on the right in FIG. 1.

This vacuum enclosure, or another, may also contain the thermal barrier 13, in order to promote thermal efficiency and ease of use.

Each enclosure 27 may comprise one or several deformable sheets 29 (FIG. 1), such as metal sheets (made of aluminium for example) or plastic sheets a few tens of mm to a few mm in thickness and sealed (welded for example) over their entire periphery.

The PCM material of the barrier 13 (if alone, or otherwise one thereof) may in particular involve encapsulated PCM (typically 0.5 to 10 mm in diameter), preferably in principle microencapsulated (typically 1 to 10 thousandths of a mm in diameter), in deformable capsules, which can therefore be made of elastomer (typically spheres) placed preferably in a porous matrix with open pores and can expand (dilate) and contract (decrease in volume), typically cellular foam, as explained above. An elastomer-based foam may in particular be selected, especially silicone, NBR, HNBR. The porous coating matrix may for example be in gel form. The foam will absorb the variations in volume of the PCM capsules by deforming. The foam may preferably include fibres loaded with thermally conductive elements such as graphite or carbon black. The PCM capsules may be one to a few mm in diameter (1 to 5 mm for example). They may have an elastomer enclosure, such that the capsules are elastically expandable.

By way of an example of PCM, PCMs such as those consisting of pure paraffin or comprising a eutectic liquid, displaying phase changes within the temperature ranges in question, may be used. However, PCMs formulated as in EP2690137 or EP2690141 are not preferred here, insofar as these PCMs would be enclosed in plastic microcapsules.

The capsule load may account for up to 85% of the foam+capsules volume when the PCM is in the crystal state.

The foam will be responsible for absorbing the 10% to 15% variation in capsule volume when the PCM is in the liquid state.

The capsule load may account for up to 95% of the foam+capsule volume when the PCM is in the liquid state.

Let us now suppose that we effectively aim to thermally manage the atmosphere within the passenger compartment 3 using the air conditioning means 9 as well as the thermally insulating element 15 and an internal thermal barrier 13 as above, in the capacity of thermal exchange with the atmosphere of the passenger compartment.

As the temperature of change of state between liquid and solid of the PCM in question, a temperature close to ambient temperature may have been selected, such as 19-22° C., 21° C. for example, or rather a substantially higher temperature on the order of 30-35° C., 33° C. for example.

Thus, as soon as the temperature influencing the barrier 13 is less than 21° C. or 33° C., the PCM will be in the solid state.

With a cross-linked PCM, embedded in and with a porous matrix with open pores of varying sizes/volumes, such as an expanding foam, solidification (crystallisation) of the PCM will cause its contraction and thus an expansion of the pores of the matrix which will then have a relatively low thermal conductivity: lower than in the liquid state of the PCM material.

The occupant's perception of the arrival of relatively cold air in the passenger compartment, blown in by the air conditioning means 9, will be rapid and noticeable, as the temperature of the air circulating in the passenger compartment will initially contribute only to a reduction in temperature in said passenger compartment owing to the thermal insulation provided both by the insulation 15, which will remain at the outside temperature, and by the barrier 13, which will contribute to creating an isotherm on the inside wall favorable to a rapid sensation of comfort.

Therefore, let us suppose that vehicle 1 has been parked outside for four hours at an external temperature (EXT) of more than 35° C. The PCM of the thermal barrier 13 is liquefied in this case. Both sides of the thermal insulation 15 may be at more than 40° C.

An occupant gets into the vehicle. S/he feels hot. The air conditioning 9 is temporarily activated, either manually by the occupant or automatically, following detection of an unsuitable temperature by the sensor 17 (preconfigured definition of a threshold temperature and programmed automatic activation of the means 9 if the threshold is reached).

The means 9 quickly blow air at 17° C. for example into the passenger compartment. A thermal flow 21 is established in contact with the wall 5.

As soon as the temperature of the air in the passenger compartment 3 acting on the barrier 13 reaches the temperature at which the PCM converts to the solid state, the transmission of this flow towards the outside is delayed. This will therefore be achieved more quickly if the temperature change of state approaches 33° C. rather than 21° C.

The temperature on the inside of thermal barrier 13 decreases rapidly. The occupant quickly has a “cool” feeling, even before this corresponds to the actual temperature within the passenger compartment.

Thus, the aim is to be able to gain 2° C. on the temperature at which the cooled air is blown into the passenger compartment compared to what needs to be achieved without a barrier and preferably without a thermally insulating element 15/internal thermal barrier 13 combination, since this combination also contributes to slowing the heat flow from the outside (at plus 35° C. in this case) towards the inside.

Another case: Following a cool night (around 10° C. for example), an occupant gets into the vehicle 1 parked outside and unused throughout the night. The air conditioning inside is activated. The means 9 subsequently blow air (at 26° C. for example) warmer than the cool temperature inside the passenger compartment (at around 10° C. in the example). For as long as the PCM concerned in the barrier 13 remains solid (crystal), lined by the insulation 15, the thermal barrier provides the greatest possible insulation. The heat pulsed by the means 9 remains inside the passenger compartment 3. The increase in temperature of the barrier is slowed. Once again, the effect is favorable to the occupant's perception, who thus more rapidly experiences a feeling of “warmth” similar to that which would be achieved if the means 9 had blown air at a higher temperature, typically 28° C., into the passenger compartment. The effect is all the more prolonged if the temperature of change of state of the PCM in question is around 33° C. rather than 21° C. The examples in FIGS. 4-5 explain the value of having a PCM temperature of change of state of between 17° C. and 25° C.

In the foregoing, the role of time manager that the thermal insulation and thermal barrier can play both will have been noted in slowing down transmission to the passenger compartment of excessive heat or cold coming from the exterior (EXT) and in the anti-dissipation action of a temperature considered suitable resulting from blowing air from the air conditioning means 9 into the passenger compartment.

The combination of the thermal insulation 15 and of the internal thermal barrier 13 is therefore beneficial:

thermally,

in terms of temperature perception by the occupant inside the passenger compartment, once the means 9 have begun to condition the air in said passenger compartment,

and therefore in terms of energy consumption by these means 9, which will have less need to blow hot or cold for the same effect on the occupant.

Considering now the cases of FIGS. 4-5, the following will be understood, assuming that the barrier 13, externally lined therefore by the thermal insulation 15, contains two PCMs having temperatures of change of state between liquid and solid of 21° C. and 33° C. respectively and dispersed in an elastomer-based porous matrix.

FIG. 4, situation A: Winter, for example; the vehicle has spent several hours outside. Outside (7) and inside the passenger compartment 3, the temperature is stabilised at 10° C., in the example.

Air conditioning at 26° C. (flow 21) is blown into the passenger compartment at t0. Both PCMs are solid. The pores of the foam are open. Conductivity of the foam is relatively low (1 W/mK in the example), higher however than that of the insulation 15 (5 mW/mK in the example).

There is little heat transfer towards the outside. The temperature increases more quickly inside the passenger compartment than in a situation without insulation, 15, or even with the insulation 15 alone.

Situation B, at t0+2-3 min.: Same as above, except that the temperature in the barrier 13 now reaches 15° C.

Situation B, at t0+3-5 min.: The temperature in the barrier 13 now reaches 21° C. The first PCM begins to liquefy. It stores heat. The latter will be released when warm air is no longer blown in via the air conditioning and the temperature in the passenger compartment drops to at least 21° C.

Liquefaction of the first MCP has caused an increase in the thermal conductivity of the barrier 13 (2-3 W/mK in the example). As noted above however, the occupant has already experienced a rapid improvement in comfort, owing to the barrier 13/insulation 15 combination, without the need to heat to 27-28° C. It has been possible to gain 1-2° C. compared to a situation without the aforementioned combination.

Situation D, at t0+5-7 min.: The temperature in the barrier 13 now reaches 23° C. The first PCM is completely liquid. A relatively low thermal flow passes through the thermal insulation 15 towards the outside. Most of the warm air flow 21 provided by the conditioned air remains inside the passenger compartment however, especially since the second PCM is still solid.

It is possible to arrange that when the temperature in the passenger compartment reaches 23° C., the sensor 17 (FIG. 1) switches off the air conditioning.

FIG. 5, situation A: Summer, for example; the vehicle has spent several hours outside. Outside (7), the temperature is 40° C. and inside the passenger compartment 3 it is higher, 55° C. in the example.

The coldest air conditioning possible, in this case at 12° C. (flow 21) is blown into the passenger compartment at t0. The pores of the foam are tightened. Conductivity of the foam is relatively high, greater than that of the insulation 15 of course. A conductivity (λ=2-5 W/mK for example) can presently be predicted for the foam that is multiplied between 2 and 3 times compared to the value when the pores of this foam are dilated.

Owing to the relatively high heat transfer in the barrier 13, the latter cools faster than without the barrier 13/insulation 15 combination.

Situation B, at t0+2-3 min.: The temperature in the barrier 13 now reaches 33° C., likewise in the passenger compartment. The temperature inside is more tolerable. The cold energy blown can be reduced: The temperature of the blown air flow 21 can increase again, in this case by 2° C., to 14° C.

The second PCM starts to solidify. The “stored cold” will be able to delay any subsequent temperature rise inside the passenger compartment, in the sun, for example during a short parking period. This crystallisation postpones cooling of the insulation 15.

Situation C, at t0+3-5 min.: The temperature in the barrier 13 now reaches 30° C. The second PCM is solid. The air conditioning in the passenger compartment, which is now at 25° C., is further reduced; the temperature of the blown air flow 21 can rise, again by 2° C., to 16° C. There is a decrease in the conductivity of the foam (intermediate value in the conductivity range: 1-1.5 W/mK for example, as only one of the PCMs has solidified).

Situation D, at t0+5-7 min.: The temperature in the barrier 13 now reaches 20° C. It is stabilised with that inside the passenger compartment.

Before being interrupted, the air conditioning in the passenger compartment is reduced again; the temperature of the blown air flow 21 rises to 18° C., almost the same temperature as in the passenger compartment. There is a further decrease in the conductivity of the foam (intermediate value in the conductivity range: 0.5 W/mK for example, as all the PCMs have solidified). The coolness of the blown air flow 21 has maximum effect.

The examples in FIG. 4-5 therefore show that with the invention, a gain is obtained compared to situations without insulation 15 and/or without barrier 13/insulation 15 combination in terms of at least some of the following aspects: energy consumed, time taken to experience comfort in the passenger compartment, extended maintenance of the effect of air conditioning in the passenger compartment after it is deactivated, under the same external conditions, increased feeling of comfort in the passenger compartment when air conditioning (hot or cold) is activated.

It should also be noted that any PCM may have a change of phase or state at a predetermined temperature peak or occurring over a more or less wide temperature range. Thus, with a pure PCM (such as a paraffin), the temperature of change of state will be constant, whereas it may not be constant with several PCMs, such as for a mixture of paraffins.

Generally speaking, both cases may be encountered in the present application in connection with the PCM(s); any PCM change of state temperature is to be considered here within a range of 10° C., and typically +1-5° C.

1. Vehicle comprising a passenger compartment delimited by walls interposed between the passenger compartment and an external environment, wherein at least one of said walls is provided with:
an internal thermal barrier with a porous matrix and containing at least one PCM material—phase-change material—capable of adopting liquid and solid states respectively, having a temperature at change of state between liquid and solid between 15° C. and 40° C. and preferably between 17° C. and 35° C., and
at least one thermally insulating element,
wherein:
from the inside in which the passenger compartment is situated, towards the outside, the vehicle comprises the internal thermal barrier followed by said at least one thermally insulating element, and
the vehicle furthermore comprises means for conditioning the air in the passenger compartment, suitable for heating, cooling and propelling air, in order to place in the latter air derived at least in part from said air conditioning means in thermal exchange with said at least one PCM material and that the porous matrix of the internal thermal barrier has open pores that differ according to the liquid or solid state of the PCM material, thus varying the thermal conductivity.

2. Vehicle according to claim 1, wherein the porous matrix comprises an expanding foam loaded with said at least one PCM material and absorbing, by deforming, variations in volume of the PCM material related to its liquid or solid state.

3. Vehicle according to claim 2, wherein the porous matrix comprises a said elastomer-based expanding foam.

4. Vehicle according to claim 1, wherein the thermal barrier has a thermal conductivity ratio between a situation in which the PCM material(s) is/are totally solid and a situation in which the PCM material(s) is/are totally liquid of comprised more than 1 and approximately 10.

5. Vehicle according to claim 1, wherein the thermal barrier comprises several said PCM materials having different temperature of change of state.

6. Vehicle according to claim 1, wherein the thermally insulating element is arranged in a vacuum enclosure in order to define at least one vacuum insulated panel, VIP.

7. Vehicle according to claim 1, wherein the change of state temperature of said at least one PCM material is greater than or equal to the highest temperature of cooling and intake of air into the passenger compartment of the air conditioning means.

8. Vehicle according to claim 1, wherein the change of state temperature of said at least one PCM material is greater than or equal to the lowest of heating and intake of air into the passenger compartment of the air conditioning means.

9. Vehicle according to claim 1, wherein the thermal barrier comprises several said PCM materials having different temperature of change of state dispersed in a medium.

10. Vehicle according to claim 5, wherein the PCM materials of the internal thermal barrier comprise at least:
a first PCM material having a temperature of change of state of between 17° C. and 25° C., and
a second PCM material having a temperature of change of state of between 25° C. and 40° C.

11. Vehicle according to claim 2, wherein said at least one PCM material of the internal thermal barrier is encapsulated and defines a volume load of up to:
85% of the volume of the foam and of said capsules, when the PCM material is in the solid, crystallised state,
and/or 95% of the volume of the foam and of the capsules when the PCM is in the liquid state.

12. Vehicle according to claim 1, wherein the porous matrix displays, under a pressure difference of 105 Pa, a deformation of less than 3%.

13. Method of thermal management of the atmosphere in a vehicle passenger compartment delimited by walls interposed between the passenger compartment and an external environment, in which method:
at least part of the walls is provided with:
an internal thermal barrier containing, in a porous matrix, at least one PCM material in thermal exchange with the passenger compartment air having a temperature of change of state between liquid and solid comprised between 15° C. and 40° C. and preferably between 17° C. and 35° C.,
and at least one thermally insulating element.
the vehicle being placed in an environment in which the PCM material is in a solid state and the temperature of air in the passenger compartment increasing to more than 20° C., the said at least one PCM material is allowed to store thermal energy by liquefying through heat exchange with this air,
wherein:
from the inside in which the passenger compartment is situated, towards the outside, the vehicle comprises the internal thermal barrier followed by said at least one thermally insulating element,
if the temperature in the passenger compartment is deemed too high, fresh conditioned air derived from air conditioning means is introduced into the passenger compartment, in thermal exchange with said at least one PCM material, so that the incoming fresh conditioned air causes solidification of said at least one PCM material, and
an element is used as an internal thermal barrier in which the porous opened-pore matrix, so that said solidification causes a decrease in the thermal conductivity of said element.
